(19) United States
(12) Patent Application Publication
(10) Pub. No.: US 2025/0060125 A1
(43) Pub. Date: Feb. 20, 2025

(54) HEAT EXCHANGER MODULE

(71) Applicant: VALEO SYSTEMES THERMIQUES, La Verriere (FR)

(72) Inventors: Hector MUNGUIA, San Luis Potosi (MX); Ricardo SANCHEZ, San Luis Potosi (MX); Jesus LEYJA, San Luis Potosi (MX); Ana-Luisa TORRES, San Luis Potosi (MX)

(73) Assignee: VALEO SYSTEMES THERMIQUES, La Verriere (FR)

(21) Appl. No.: 18/449,900

(22) Filed: Aug. 15, 2023

(51) Int. Cl. F24F 13/02; F24F 1/0029; F24F 1/0059

(52) U.S. Cl. CPC F24F 13/0209; F24F 1/0029; F24F 1/0059

(57) ABSTRACT

A heat exchanger module including: a first heat exchanger configured to exchange heat with air; a fan unit configured to induce flow of the air through the first heat exchanger; and an air duct configured to guide the flow of the air from the fan unit to the first heat exchanger. The air duct includes a first duct portion, a second duct portion and a third duct portion, with the first duct portion and the second duct portion being connected to the first heat exchanger, and the third duct portion being connected to the fan unit.

### TECHNICAL FIELD

The present invention relates to a heat exchanger module, particularly to the manner of connecting various parts in the heat exchanger module.

### BACKGROUND OF THE INVENTION

Generally, a vehicle comprises a heat exchanger module configured to exchange heat with air. The heat exchanger module is preferably arranged in a front end of the vehicle in the flow of air. The heat exchanger module comprises various parts such as at least one heat exchanger, air duct and fan unit connected together. Further, the vehicle comprises a plurality of moving parts, such as engine and motor that generate vibrations upon operation. The vibrations generated by the plurality of the moving parts are transmitted to the heat exchanger module. Therefore, connection of the various parts in the heat exchanger module should be capable of withstanding the vibrations transmitted thereto from the plurality of moving parts.

### SUMMARY OF THE INVENTION

An objective of the present invention is to provide a heat exchanger module that alleviates the problems in the prior arts. To be more precise, an objective of the present invention is to provide a robust connection of various parts in a heat exchanger module.

To achieve the above objectives, an embodiment of the present invention herein provides a heat exchanger module. The heat exchanger module comprising: a first heat exchanger configured to exchange heat with air; a fan unit connected to the first heat exchanger and configured to induce flow of the air through the first heat exchanger; and an air duct connected to the first heat exchanger and the fan unit, and configured to guide the flow of the air to the first heat exchanger, wherein the air duct, at a first duct portion and a second duct portion located at a distance from the first duct portion, are connected to the first heat exchanger, and at a third duct portion connecting the first duct portion and the second duct portion, is connected to the fan unit.

In one aspect, the heat exchanger module is an inclined heat exchanger module.

In another aspect, the first heat exchanger is arranged between the fan unit and the air duct in the flow of the air.

In another aspect, the air duct comprises a quadrilateral shape with an upper duct side, a lower duct side, a first lateral duct side and a second lateral duct side, when viewed in a direction parallel to the flow of the air.

In another aspect, the first duct portion and the second duct portion of the air duct are the first lateral duct side and the second lateral duct side of the air duct.

In another aspect, the first lateral duct side and the second lateral duct side of the air duct are connected to a primary-first collector and a secondary-first collector of the first heat exchanger respectively by a first fastener.

In another aspect, the third duct portion of the air duct is the upper duct side of the air duct.

In another aspect, the upper duct side of the air duct is connected to an upper fan side of the fan unit by a second fastener.

In another aspect, the lower duct side of the air duct is connected to the fan unit.

In another aspect, the lower duct side of the air duct is connected to a lower fan side of the fan unit by a third fastener.

In another aspect, a first lateral fan side and a second lateral fan side of the fan unit are connected to the first heat exchanger.

In another aspect, the first lateral fan side and the second lateral fan side of the fan unit are connected to the primary-first collector and the secondary-first collector of the first heat exchanger respectively by a fourth fastener.

In another aspect, the heat exchanger module comprises a second heat exchanger connected to the first heat exchanger and configured to exchange heat with air.

In another aspect, the second heat exchanger is arranged between the first heat exchanger and the fan unit in the flow of the air.

In another aspect, a primary-second lateral side and a secondary-second lateral side of the second heat exchanger are connected to the first heat exchanger.

In another aspect, a primary-second collector and a secondary-second collector of the second heat exchanger are connected to the primary-first collector and the secondary-first collector of the first heat exchanger respectively.

In another aspect, the first heat exchanger is a radiator and the second heat exchanger is a condenser.

In another aspect, a receiver dryer connected to the second heat exchanger, is connected to the first heat exchanger.

In another aspect, the receiver dryer is connected to the primary-first collector of the first heat exchanger.

According to the above embodiments, the air duct is connected to the first heat exchanger and the fan unit, and the fan unit is connected to the first heat exchanger. Therefore, a robust connection of various parts in the heat exchanger module capable of withstanding vibrations is achieved.

### BRIEF DESCRIPTION OF DRAWINGS

Other characteristics, details and advantages of the invention can be inferred from the description of the invention hereunder. A more complete appreciation of the invention and many of the attendant advantages thereof will be readily obtained, as the same becomes better understood by reference to the following description when considered in connection with the accompanying figures, wherein:

FIG. 1 illustrates a perspective view of a heat exchanger module, in accordance with an embodiment of the present invention;

FIG. 2 illustrates another perspective view of the heat exchanger module of FIG. 1;

FIG. 3 illustrates an exploded view of the heat exchanger module of FIG. 1; and

FIG. 4 illustrates a perspective view of an assembly of a first heat exchanger and a second heat exchanger in the heat exchanger module of FIG. 1.

### DETAILED DESCRIPTION OF THE INVENTION

It must be noted that the figures disclose the invention in a detailed enough way to be implemented, the figures helping to better define the invention, if need be. The invention should however not be limited to the embodiments disclosed in the description.

In the present description, some elements or parameters may be indexed, such as a first element and a second element. In this case, unless stated otherwise, this indexation is only meant to differentiate and name elements that are similar but not identical. No idea of priority should be inferred from such indexation, as these may be switched without betraying the invention. Additionally, this indexation does not imply any order in mounting or use of the elements of the invention.

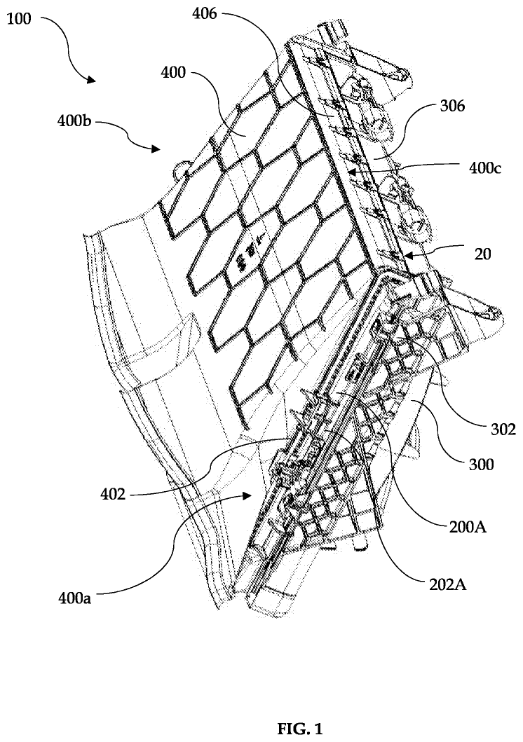

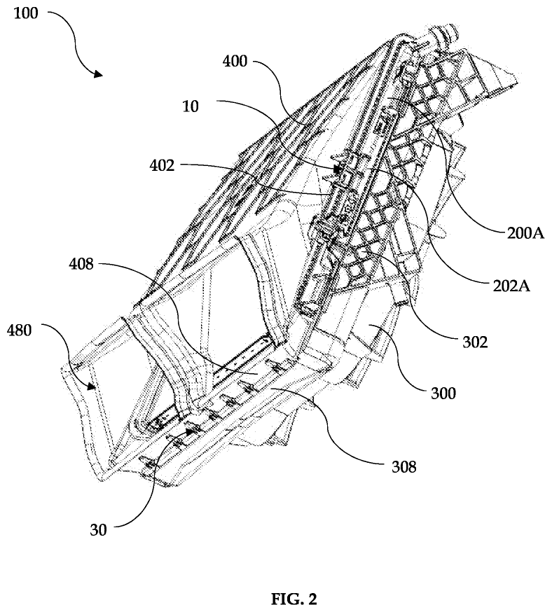

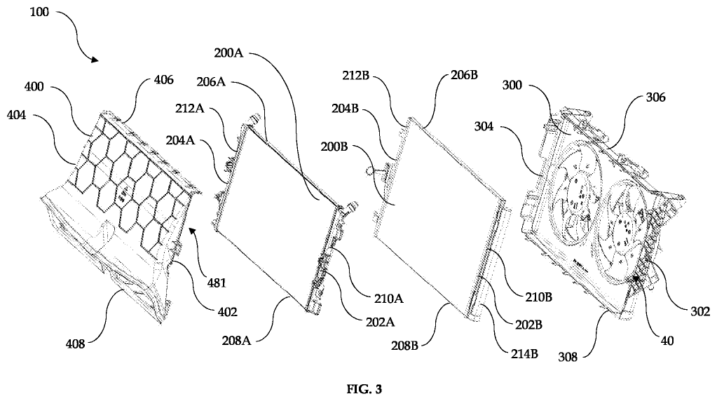

FIG. 1 and FIG. 2 illustrate different perspective views of a heat exchanger module 100, in accordance with an embodiment of the present invention. FIG. 3 illustrates an exploded view of the heat exchanger module 100 of FIG. 1. The heat exchanger module 100 comprises at least one heat exchanger 200A, 200B configured to exchange heat with air; a fan unit 300 adapted to connect to the at least one heat exchanger 200A, 200B and configured to induce the flow of air across the at least one heat exchanger 200A, 200B; and an air duct 400 adapted to connect to the at least one heat exchanger 200A, 200B and the fan unit 300, and configured to guide the flow of air to the at least one heat exchanger 200A, 200B. By the term ‘guide’ here it can be meant guiding in a sealing manner, to avoid air escaping to the sides and ensuring that all the air from the air duct 400 goes through the heat exchanger 200A, 200B. The air duct 400, at two or more duct portions, is adapted to connect to the at least one heat exchanger 200A, 200B, and at one or more duct portions, is adapted to connect to the fan unit 300. The air duct 400 constitutes an air channel extending between an air inlet 480 and an air outlet 481. The air outlet 481 delivers air to the heat exchanger 200A, 200B as it is propelled by the fan unit 300.

In one embodiment, the heat exchanger module 100 can comprise a first heat exchanger 200A configured to exchange heat with air. The heat exchanger module 100 can comprise the fan unit 300 adapted to connect to the first heat exchanger 200A and configured to induce the flow of air across the first heat exchanger 200A. The heat exchanger module 100 can comprise the air duct 400 adapted to connect to the first heat exchanger 200A and configured to guide the flow of air to the first heat exchanger 200A. The air duct 400 can be adapted to connect to the fan unit 300, in addition to the first heat exchanger 200A. The air duct 400, at a first duct portion 400a and a second duct portion 400b, can be adapted to connect to the first heat exchanger 200A and at a third duct portion 400c, can be adapted to connect to the fan unit 300. The first duct portion 400a and the second duct portion 400b can connected directly to the first heat exchanger 200A, and the third duct portion 400c being connected directly to the fan unit 300. By a direct connection, it can be meant here that there are no substantial, intermediate, thermally functional components of the heat exchange module 100 between the components being connected, like e.g. another heat exchanger, fan unit etc.

In one aspect, the heat exchanger module 100 can be a vertical heat exchanger module, wherein the first heat exchanger 200A is arranged in a vertical manner. In another aspect, the heat exchanger module 100 can be an inclined heat exchanger module, wherein the first heat exchanger 200A is arranged in an inclined manner. The angular reference can be made with respect to the ground (e.g. flat and non-inclined road on which a vehicle equipped with the heat exchange module 100 is situated).

In another aspect, the first heat exchanger 200A can be arranged between the fan unit 300 and the air duct 400 in the flow of air. In one example, the air duct 400 can be arranged upstream of the first heat exchanger 200A in the flow of air and configured to guide the flow of air to the first heat exchanger 200A. The fan unit 300 can be arranged downstream of the first heat exchanger 200A in the flow of air and configured to induce the flow of air across the first heat exchanger 200A.

In another aspect, the second duct portion 400b of the air duct 400 can be located at a distance from the first duct portion 400a of the air duct 400. In another example, the second duct portion 400b of the air duct 400 can be located opposite to the first duct portion 400a of the air duct 400. In another aspect, the third duct portion 400c of the air duct 400 can be connecting the first duct portion 400a and the second duct portion 400b of the air duct 400. In another example, the third duct portion 400c of the air duct 400 can be located adjacent to the first duct portion 400a and the second duct portion 400b of the air duct 400.

In another aspect, the air duct 400 can have a polygon shape when viewed in a direction parallel to the flow of air. In another example, the air duct 400 can have a quadrilateral shape with an upper duct side 406, a lower duct side 408, a first lateral side 402 and a second lateral side 404. The upper, lower and lateral sides are meant to be referenced for example with respect to the ground (e.g. flat and non-inclined road on which a vehicle equipped with the heat exchange module 100 is situated). In another example, the first duct portion 400a and the second duct portion 400b of the air duct 400 adapted to connect to the first heat exchanger 200A, can be the first lateral duct side 402 and the second lateral duct side 404 of the air duct 400. The first lateral duct side 402 and the second lateral duct side 404 of the air duct 400 can be adapted to connect to a primary-first lateral side 202A and a secondary-first lateral side 204A of the first heat exchanger 200A respectively, e.g with a direct connection. In another example, the first lateral duct side 402 and the second lateral duct side 404 of the air duct 400 can be adapted to connect to a primary-first collector 210A and a secondary-first collector 212A of the first heat exchanger 200A respectively, wherein the primary-first collector 210A and the secondary-first collector 212A of the first heat exchanger 200A are located at the primary-first lateral side 202A and the secondary-first lateral side 204A of the first heat exchanger 200A respectively.

In another aspect, the first duct portion 400a and the second duct portion 400b of the air duct 400 can be adapted to connect to the first heat exchanger 200A by a first fastener 10. The first fastener 10 can be any type of fastener, such as but not limited to clip, bracket, slot, orifice, screw or bolt/nut. In another example, the first lateral duct side 402 and the second lateral duct side 404 of the air duct 400 can be adapted to connect to the primary-first collector 210A and the secondary-first collector 212A of the first heat exchanger 200A respectively by a clip fastener. The first lateral side duct 402 and the second lateral duct side 404 of the air duct 400 can be provided with one or more clip fasteners, and the primary-first collector 210A and the secondary-first collector 212A of the first heat exchanger 200A can be provided with one or more counter clip fasteners adapted to connect with the one or more clip fasteners respectively.

In another example, the third duct portion 400c of the air duct 400 adapted to connect to the fan unit 300, can be the upper duct side 406 of the air duct 400. The upper duct side 406 of the air duct 400 can be adapted to connect to an upper fan side 306 of the fan unit 300. In another aspect, the third duct portion 400c of the air duct 400 can be adapted to connect to the fan unit 300 by a second fastener 20. The second fastener 20 can be any type of fastener, such as but not limited to clip, bracket, slot, orifice, screw or bolt/nut. In another example, the upper duct side 406 of the air duct 400 can be adapted to connect to the upper fan side 306 of the fan unit 300 by a clip fastener. The upper duct side 406 of the air duct 400 can be provided with one or more clip fasteners, and the upper fan side 306 of the fan unit 300 can be provided with one or more counter clip fasteners adapted to connect with the one or more clip fasteners respectively.

In another example, the lower duct side 408 of the air duct 400 can be adapted to connect to the fan unit 300, in addition to the upper duct side 406 of the air duct 400. The lower duct side 408 of the air duct 400 can be adapted to connect to a lower fan side 308 of the fan unit 300. In another aspect, the lower duct side 408 of the air duct 400 can be adapted to connect to the fan unit 300 by a third fastener 30. The third fastener 30 can be any type of fastener, such as but not limited to clip, bracket, slot, orifice, screw or bolt/nut. In another example, the lower duct side 408 of the air duct 400 can be adapted to connect to the lower fan side 308 of the fan unit 300 by a clip fastener. The lower duct side 408 of the air duct 400 can be provided with one or more clip fasteners, and the lower fan side 308 of the fan unit 300 can be provided with one or more counter clip fasteners adapted to connect with the one or more clip fasteners respectively.

In another aspect, the lower duct side 408 of the air duct 400 can be adapted to connect to the lower fan side 308 of the fan unit 300 by resting connection. In another example, the lower duct side 408 of the air duct 400 can abut against and rest above the lower fan side 308 of the fan unit 300. In another example, the lower fan side 308 of the fan unit 300 can abut against and rest above the lower duct side 408 of the air duct 400. The lower duct side 408 of the air duct 400 and the lower fan side 308 of the fan unit 300 are retained in position by weight of the air duct 400, the first heat exchanger 200A and the fan unit 300, and force applied by the first fastener 10, the second fastener 20 and the third fastener 30.

In another aspect, a first lateral fan side 302 and a second lateral fan side 304 of the fan unit 300 can be adapted to connect to the first heat exchanger 200A. The first lateral fan side 302 and the second lateral fan side 304 of the fan unit 300 can be adapted to connect to the primary-first lateral side 202A and the secondary-first lateral side 204A of the first heat exchanger 200A respectively. In another example, the first lateral fan side 302 and the second lateral fan side 304 of the fan unit 300 can be adapted to connect to the primary-first collector 210A and the secondary-first collector 212A of the first heat exchanger 200A respectively.

In another aspect, the first lateral fan side 302 and the second lateral fan side 304 of the fan unit 300 can be adapted to connect to the first heat exchanger 200A by a fourth fastener 40. The fourth fastener 40 can be any type of fastener, such as but not limited to clip, bracket, slot, orifice, screw or bolt/nut. In another example, the first lateral fan side 302 and the second lateral fan side 304 of the fan unit 300 can be adapted to connect to the primary-first collector 210A and the secondary-first collector 212A of the first heat exchanger 200A respectively by screws. The first lateral fan side 302 and the second lateral fan side 304 of the fan unit 300 and the primary-first collector 210A and the secondary-first collector 212A of the first heat exchanger 200A can be provided with one or more orifices adapted to engage with screws.

In another embodiment, the heat exchanger module 100 can comprise a second heat exchanger 200B configured to exchange heat with air, in addition to the first heat exchanger 200A. In another aspect, the second heat exchanger 200B can be arranged between the fan unit 300 and the air duct 400 in the flow of air. In another example, the second heat exchanger 200B can be arranged between the first heat exchanger 200A and the fan unit 300 in the flow of air. The second heat exchanger 200B can be arranged downstream of the first heat exchanger 200A and the fan unit 300 can be arranged downstream of the second heat exchanger 200B in the flow of air, wherein the fan unit 300 is configured to induce the flow of air across the first heat exchanger 200A and the second heat exchanger 200B.

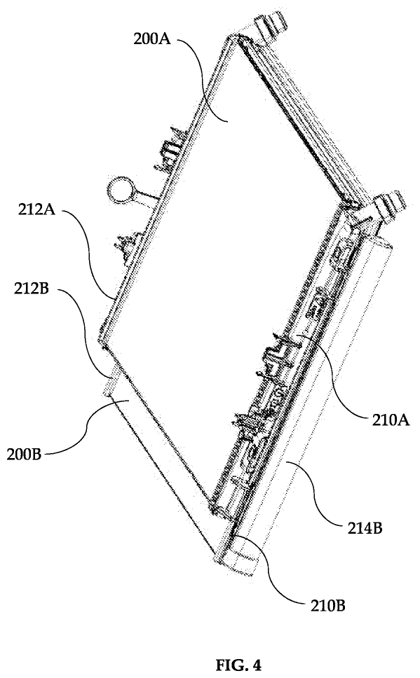

FIG. 4 illustrates an assembly of the first heat exchanger 200A and the second heat exchanger 200B in the heat exchanger module 100 of FIG. 1. In another aspect, the second heat exchanger 200B can be adapted to connect to the first heat exchanger 200A. In another aspect, two sides of the second heat exchanger 200B can be adapted to connect to the first heat exchanger 200A. In another example, a primary-second lateral side 202B and a secondary-second lateral side 204B of the second heat exchanger 200B can be adapted to connect to the first heat exchanger 200A. The primary-second lateral side 202B and the secondary-second lateral side 204B of the second heat exchanger 200B can be adapted to connect to the primary-first lateral side 202A and the secondary-first lateral side 204A of the first heat exchanger 200A respectively. In another example, the primary-second lateral side 202B and the secondary-second lateral side 204B of the second heat exchanger 200B can be adapted to connect to the primary-first collector 210A and the secondary-first collector 212A of the first heat exchanger 200A respectively. In another example, a primary-second collector 210B and a secondary-second collector 212B of the second heat exchanger 200B can be adapted to connect to the primary-first collector 210A and the secondary-first collector 212A of the first heat exchanger 200A respectively, wherein the primary-second collector 210B and the secondary-second collector 212B of the second heat exchanger 200B are located at the primary-second lateral side 202B and the secondary-second lateral side 204B of the second heat exchanger 200B respectively.

In another aspect, the first heat exchanger 200A can be a radiator and the second heat exchanger 200B can be a condenser. In another aspect, a receiver dryer 210B connected to the second heat exchanger 200B, can be adapted to connect to the first heat exchanger 200A, e.g. with a direct connection. In another example, the receiver dryer 214B can be in fluid communication with the primary-second collector 210B of the second heat exchanger 200B and located at the primary-second lateral side 202B of the second heat exchanger 200B. The receiver dryer 210B can be adapted to connect to the primary-first collector 210A of the first heat exchanger 200A. In another example, the receiver dryer 214B can be in fluid communication with the secondary-second collector 212B of the second heat exchanger 200B and located at the secondary-second lateral side 204B of the second heat exchanger 200B. The receiver dryer 210B can be adapted to connect to the secondary-first collector 212A of the first heat exchanger 200A.

In another example, the second heat exchanger 200B can be arranged between the air duct 400 and the first heat exchanger 200A in the flow of air. The second heat exchanger 200B can be arranged downstream of the air duct 400 and the first heat exchanger 200A can be arranged downstream of the second heat exchanger 200B in the flow of air, wherein the air duct 400 is configured to guide the flow of air to the first heat exchanger 200A and the second heat exchanger 200B.

In another example, the upper duct side 406 and the lower duct side 408 of the air duct 400 can be adapted to connect to the first heat exchanger 200A. The upper duct side 406 and the lower duct side 408 of the air duct 400 can be adapted to connect to primary-first collector 210A and the secondary-first collector 212A of the first heat exchanger 200A respectively, wherein the primary-first collector 210A and the secondary-first collector 212A of the first heat exchanger 200A are located at a first upper side 206A and a first lower side 208A of the first heat exchanger 200A respectively.

In another example, the first lateral duct side 402 and the second lateral duct side 404 of the air duct 400 can be adapted to connect to the fan unit 300. The first lateral side duct 402 and the second lateral duct side 404 of the air duct 400 can be adapted to connect to the first lateral fan side 302 and the second lateral fan side 304 of the fan unit 300 respectively.

In another example, the upper fan side 306 and the lower fan side 308 of the fan unit 300 can be adapted to connect to the first heat exchanger 200A. In another example, the upper fan side 306 and the lower fan side 308 of the fan unit 300 can be adapted to connect to the primary-first collector 210A and the secondary-first collector 212A of the first heat exchanger 200A respectively.

In another example, a second upper side 206B and a second lower side 208B of the second heat exchanger 200B can be adapted to connect to the first heat exchanger 200A. The primary-second collector 210B and the secondary-second collector 212B of the second heat exchanger 200B can be adapted to connect to the primary-first collector 210A and the secondary-first collector 212A of the first heat exchanger 200A respectively, wherein the primary-second collector 210B and the secondary-second collector 212B of the second heat exchanger 200B are located at the second upper side 206B and the second lower side 208B of the second heat exchanger 200B respectively.

In another aspect, the heat exchanger module 100 can be provided in a vehicle. In another example, the heat exchanger module 100 can be provided in a front end of the vehicle in the flow of air. The heat exchanger module 100 described in the above embodiments can be adapted to any technical field and should not be limited to automotive field alone.

According to the above-described embodiments, the first lateral duct side 402 and the second lateral duct side 404 of the air duct 400 are adapted to connect to the first heat exchanger 200A, and the upper duct side 406 and the lower duct side 408 of the air duct 400 are adapted to connect to the fan unit 300. The first lateral fan side 302 and the second lateral fan side 304 of the fan unit 300 are adapted to connect to the first heat exchanger 200A. Therefore, a robust connection of various parts in the heat exchanger module 100 capable of withstanding vibrations is achieved.

All the above-described embodiments are just to explain the present invention while more embodiments and combinations thereof might exist. Hence, the present invention should not be limited to the above-described embodiments alone.

1. A heat exchanger module comprising:
a first heat exchanger configured to exchange heat with air;
a fan unit configured to induce flow of the air through the first heat exchanger; and
an air duct configured to guide the flow of the air to the first heat exchanger;
wherein the air duct includes a first duct portion, a second duct portion and a third duct portion, with the first duct portion and the second duct portion being connected to the first heat exchanger, and the third duct portion being connected to the fan unit.

2. The heat exchanger module as claimed in claim 1, wherein the heat exchanger module is an inclined heat exchanger module.

3. The heat exchanger module as claimed in claim 1, wherein the first heat exchanger is arranged between the fan unit and the air duct along the flow of the air.

4. The heat exchanger module as claimed in claim 1, wherein the air duct has a quadrilateral shape with an upper duct side, a lower duct side, a first lateral duct side and a second lateral duct side, when viewed in a direction of the flow of the air.

5. The heat exchanger module as claimed in claim 4, wherein the first duct portion is the first lateral duct side of the air duct and the second duct portion is the second lateral duct side of the air duct.

6. The heat exchanger module as claimed in claim 4, wherein the first heat exchanger includes a primary-first collector and a secondary-first collector, with the first duct portion being connected to the primary-first collector and the second duct portion being connected to the secondary-first collector.

7. The heat exchanger module as claimed in claim 4, wherein the third duct portion is the upper duct side.

8. The heat exchanger module as claimed in claim 7, wherein the fan unit includes an upper fan side, with the upper duct side being connected to the upper fan side.

9. The heat exchanger module as claimed in claim 7, wherein the lower duct side is connected to the fan unit.

10. The heat exchanger module as claimed in claim 9, wherein the fan unit includes a lower fan side, with the lower duct side being connected to the lower fan side.

11. The heat exchanger module as claimed in claim 9, wherein the fan unit includes a first lateral fan side and a second lateral fan side, with the first lateral fan side and the second lateral fan side being connected to the first heat exchanger.

12. The heat exchanger module as claimed in claim 11, wherein the first heat exchanger includes a primary-first collector and a secondary-first collector, with the first lateral fan side being connected to the primary-first collector and the second lateral fan side being connected to the secondary-first collector.

13. The heat exchanger module as claimed in claim 1, further comprising a second heat exchanger connected to the first heat exchanger and configured to exchange heat with air.

14. The heat exchanger module as claimed in claim 13, wherein the second heat exchanger is arranged between the first heat exchanger and the fan unit in the flow of the air.

15. The heat exchanger module as claimed in claim 14, wherein the second heat exchanger includes a primary-second lateral side and a secondary-second lateral side, with the primary-second lateral side and the secondary-second lateral side being connected to the first heat exchanger.

16. The heat exchanger module as claimed in claim 15, wherein the primary-second collector and the secondary-second collector of the second heat exchanger are connected respectively to the primary-first collector and the secondary-first collector of the first heat exchanger respectively.

17. The heat exchanger module as claimed in claim 1, wherein the first heat exchanger is a radiator.

18. The heat exchanger module as claimed in claim 13, wherein the second heat exchanger is a condenser.

19. The heat exchanger module as claimed in claim 18, wherein the second heat exchanger includes a receiver dryer, the receiver dryer being connected to the first heat exchanger.

20. The heat exchanger module as claimed in claim 19, wherein the first heat exchanger includes a primary-first collector and a secondary-first collector, with the receiver dryer being connected to the primary-first collector.
